(19) United States
(12) Patent Application Publication
(10) Pub. No.: US 2022/0317629 A1
(43) Pub. Date: Oct. 6, 2022

(54) Electronic Watch

(71) Applicant: Seiko Epson Corporation, Tokyo (JP)

(72) Inventor: Fumiaki MIYAHARA, Ina (JP)

(21) Appl. No.: 17/706,778

(22) Filed: Mar. 29, 2022

(30) Foreign Application Priority Data
Mar. 30, 2021 (JP) 2021-056847

(51) Int. Cl. G04C 9/00; G04C 1/08; G04C 10/00; G04G 17/04

(52) U.S. Cl. CPC G04C 9/02; G04C 1/08; G04C 10/00; G04G 17/04

(57) ABSTRACT

An electronic watch of the present disclosure includes a power generation device having a rotating weight rotating about a rotary shaft, and configured to convert mechanical energy obtained by rotation of the rotating weight into electrical energy, a clocking device configured to clock time, and an antenna disposed on an inner side in a radial direction of the rotating weight than a rotational trajectory of an outer peripheral edge of the rotating weight in plan view viewed from an axial direction of the rotary shaft, and configured to be capable of receiving a long wave standard radio wave, wherein the rotating weight has an opening portion or a notch portion disposed at a position that enables the rotating weight to overlap with the antenna in plan view, and does not cover the entire antenna in plan view regardless of a rotational position.

The present application is based on, and claims priority from JP Application Serial Number 2021-056847, filed Mar. 30, 2021, the disclosure of which is hereby incorporated by reference herein in its entirety.

### BACKGROUND

### 1. Technical Field

The present disclosure relates to an electronic watch.

### 2. Related Art

JP 2004-3993 A discloses an electronic watch having an antenna capable of receiving a standard radio wave including time information, and including a power generation mechanism for generating power using a rotating weight.

In JP 2004-3993 A, in plan view, the antenna is disposed on an outer side in a radial direction of the rotating weight than a rotational trajectory of an outer peripheral edge of the rotating weight, that is, the antenna is disposed at a position that does not overlap with the rotating weight, wherever the rotating weight is. As a result, even when the rotating weight rotates while a standard radio wave is being received by the antenna, the standard radio wave is not shielded by the rotating weight, so the standard radio wave can be reliably received by the antenna.

In JP 2004-3993 A, since the antenna is disposed on the outer side in the radial direction of the rotating weight than the rotational trajectory of the outer peripheral edge of the rotating weight, and it is necessary to provide an extra space for disposing the antenna, there was a problem in that the watch was increased in size.

### SUMMARY

An electronic watch of the present disclosure includes a power generation device having a rotating weight rotating about a rotary shaft, and configured to convert mechanical energy obtained by rotation of the rotating weight into electrical energy, a clocking device configured to clock time, and an antenna disposed on an inner side in a radial direction of the rotating weight than a rotational trajectory of an outer peripheral edge of the rotating weight in plan view viewed from an axial direction of the rotary shaft, and configured to be capable of receiving a long wave standard radio wave, wherein the rotating weight has an opening portion or a notch portion disposed at a position that enables the rotating weight to overlap with the antenna in the plan view, and does not cover the entire antenna in the plan view regardless of a rotational position.

### BRIEF DESCRIPTION OF THE DRAWINGS

FIG. 1 is a front view illustrating an outline of an electronic watch according to a first exemplary embodiment of the present disclosure.

FIG. 2 is a block diagram illustrating a schematic configuration of the electronic watch of the first exemplary embodiment.

FIG. 3 is a block diagram illustrating a schematic configuration of a receiving circuit of the first exemplary embodiment.

FIG. 4 is a plan view illustrating an antenna of the first exemplary embodiment.

FIG. 5 is a plan view illustrating the antenna viewed from a direction opposite to that of FIG. 4.

FIG. 6 is a plan view illustrating an outline of a rotating weight and the antenna of the first exemplary embodiment.

FIG. 7 is a cross-sectional view illustrating an outline of the rotating weight and the antenna of the first exemplary embodiment.

FIG. 8 is a diagram showing a relationship between overlap ratio of a coil portion and antenna tuning frequency fluctuation ratio.

FIG. 9 is a plan view illustrating an outline of a rotating weight and an antenna of a second exemplary embodiment.

FIG. 10 is a plan view illustrating an outline of a rotating weight and an antenna of a third exemplary embodiment.

FIG. 11 is a plan view illustrating an outline of a rotating weight and an antenna of a fourth exemplary embodiment.

### DESCRIPTION OF EXEMPLARY EMBODIMENTS

### First Exemplary Embodiment

A first exemplary embodiment of the present disclosure will be described below with reference to the drawings.

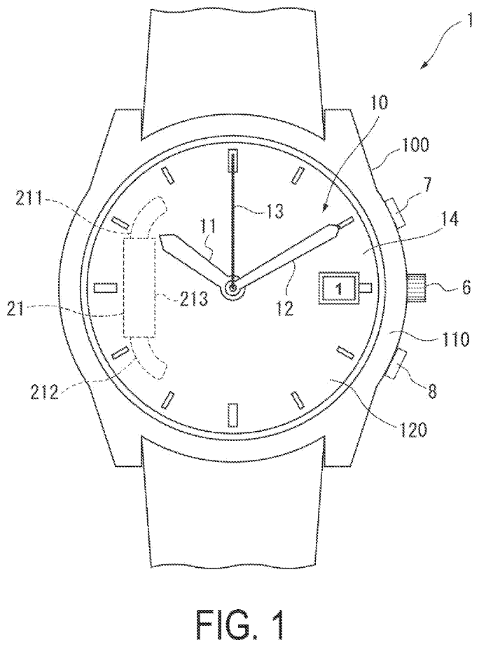

FIG. 1 is a plan view illustrating an electronic watch 1 of the present exemplary embodiment.

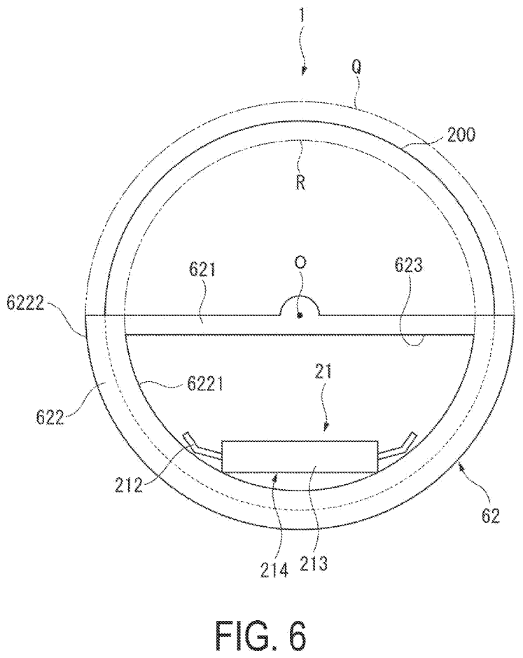

As illustrated in FIG. 1, the electronic watch 1 is an analog watch including a display means 10, a crown 6, an A button 7, a B button 8, an antenna 21, an outer case 100, and a movement 200 (see FIG. 6).

The outer case 100 includes a casing 110, a cover glass 120, and a case back (not illustrated).

The casing 110 is formed of a metal member made of stainless steel, brass, titanium, or the like. The casing 110 is formed in a substantially cylindrical shape, and an inner circumferential surface is formed in a substantially circular shape in a plane. The cover glass 120 is mounted to a front surface side of the casing 110. The case back is formed of a metal material similar to the casing 110, and is fixed to a rear surface opening of the casing 110.

The display means 10 includes an hour hand 11, a minute hand 12, a seconds hand 13, and a dial 14. Then, the electronic watch 1 is a watch capable of receiving a long wave standard radio wave, and correcting indicated positions by the hour hand 11, the minute hand 12, and the seconds hand 13, respectively, based on received time information.

Here, the dial 14 may be formed of a non-electrically conductive material such as a synthetic resin or ceramic, and thus, a long wave standard radio wave entering from the cover glass 120 side described below is not inhibited, and can be favorably received by the antenna 21 described below.

The movement 200 is housed within the outer case 100. Then, the movement 200 is configured to include the antenna 21, a circuit unit 30, an electrical storage means 40, a rectifier circuit 50, a power generation device 60, and the like described below.

Circuit Configuration of Electronic Watch

Next, a circuit configuration of the electronic watch 1 of the present exemplary embodiment will be described.

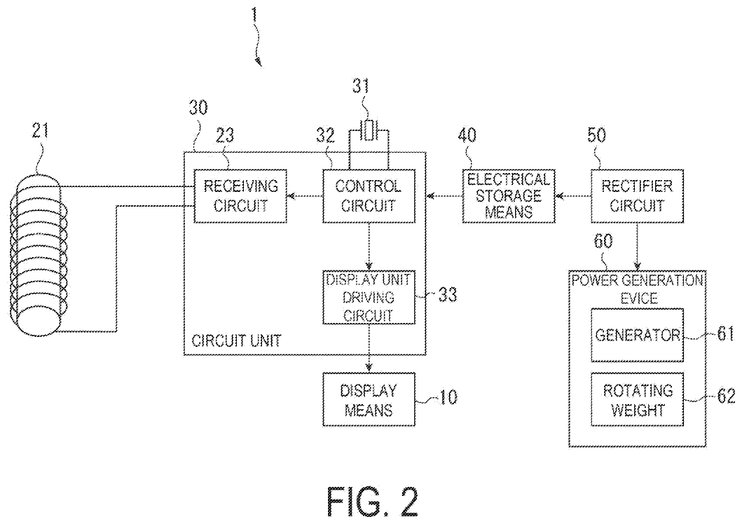

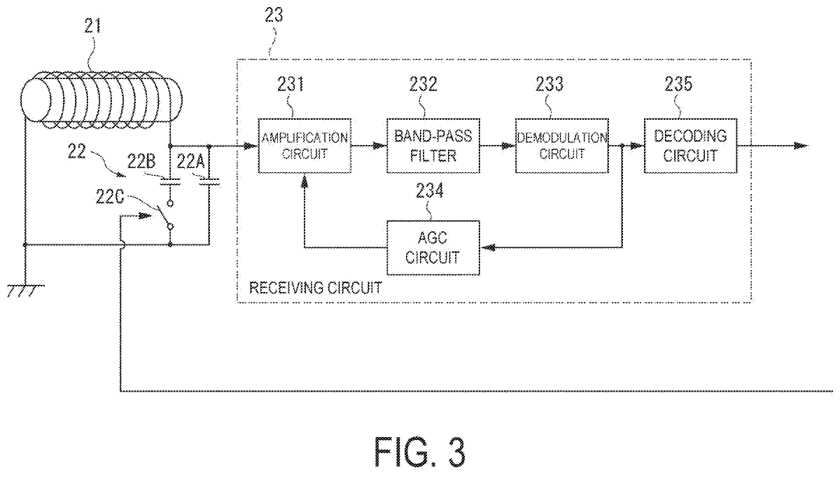

FIG. 2 is a block diagram illustrating a schematic configuration of the electronic watch 1, and FIG. 3 is a block diagram illustrating a schematic configuration of a receiving circuit 23.

As illustrated in FIG. 2 and FIG. 3, the electronic watch 1 includes the display means 10, the antenna 21, a tuning circuit 22, the receiving circuit 23, the circuit unit 30, a crystal oscillator 31, the electrical storage means 40, the rectifier circuit 50, and the power generation device 60.

Antenna

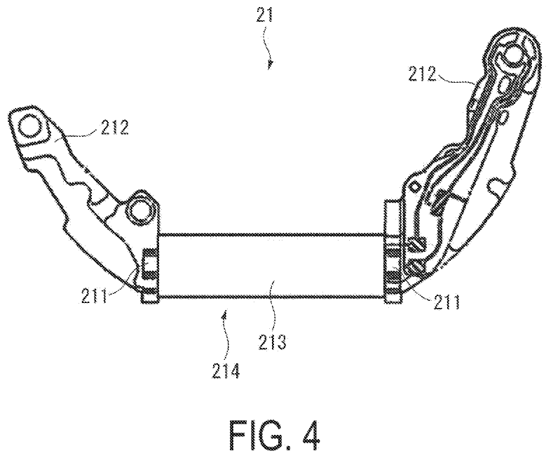

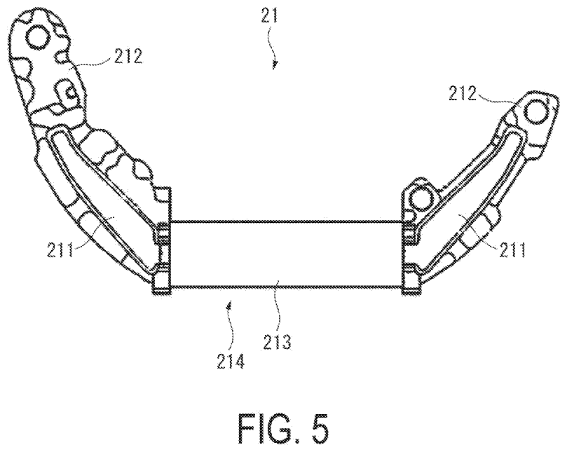

FIG. 4 is a plan view illustrating the antenna 21, and FIG. 5 is a plan view illustrating the antenna 21 viewed from a direction opposite to that illustrated in FIG. 4.

As illustrated in FIG. 4 and FIG. 5, the antenna 21 is configured by winding a coil 213 around an antenna core portion 211 and an antenna frame 212, and is, as necessary, insulated by cation electrodeposition coating or the like having excellent corrosion resistance. Then, in the antenna core portion 211, a portion where the coil 213 is wound is a coil portion 214.

The antenna core portion 211 is obtained by, for example, punching a cobalt based amorphous metal foil (e.g.; amorphous sheet with Co 50 wt % or more) as a magnetic foil material, with a mold, or bonding and overlaying 10 to 30 sheets of those molded by etching, and performing heat treatment such as annealing to stabilize magnetic properties.

The antenna frame 212 is a member made of a synthetic resin, and holds the antenna core portion 211.

When receiving a long wave standard radio wave (40 to 77.5 kHz), the coil 213 needs an inductance value of approximately 20 mH. For this reason, in the present exemplary embodiment, the coil 213 is configured by winding a uremet wire having a diameter of approximately 0.1 mm for several hundred turns.

Further, the winding method of the coil 213 is not particularly limited, and may be irregular winding or the like, but regular winding is particularly desirable. Employing the regular winding eliminates a wasted space between coil wire materials, and can reduce coil volume to achieve the same inductance value.

Such an antenna 21 is disposed in a 9 o'clock direction relative to a center of the outer case 100. On the other hand, the crown 6 is disposed on a 3 o'clock side of the outer case 100.

Then, in the present exemplary embodiment, the crown 6 is disposed at a 3 o'clock position, and the A button 7 and the B button 8 are disposed at a 2 o'clock position and a 4 o'clock position, respectively.

That is, in the present exemplary embodiment, the antenna 21 and the crown 6, the A button 7, and the B button 8 are disposed on opposite sides to each other so as to sandwich a planar center position of the outer case 100.

Tuning Circuit

Returning to FIG. 2 and FIG. 3, the tuning circuit 22 is configured to include two capacitors 22A, and 22B coupled in parallel to the antenna 21, and the capacitor 22B on one side is coupled to the antenna 21 via a switch 22C.

Receiving Circuit

The receiving circuit 23 includes an amplification circuit 231, a band-pass filter 232, a demodulation circuit 233, an AGC circuit 234, and a decoding circuit 235.

The amplification circuit 231 amplifies a long wave standard radio wave signal received by the antenna 21. The band-pass filter 232 only extracts a desired frequency component from the amplified long wave standard radio wave signal. The demodulation circuit 233 smooths and demodulates the long wave standard radio wave signal. The AGC (Automatic Gain Control) circuit 234 performs gain control of the amplification circuit 231, and performs control so that a reception level of the long wave standard radio wave signal is constant. The decoding circuit 235 decodes and outputs the demodulated long wave standard radio wave signal.

Then, time information received in the receiving circuit 23 and subjected to signal processing is output to a storage circuit (not illustrated) and stored.

Further, in the present exemplary embodiment, the receiving circuit 23 starts receiving time information based on a reception control signal output from the control circuit 32, by a predetermined schedule or a reception operation with the crown 6, the A button 7, the B button 8, and the like.

Circuit Unit

The circuit unit 30 includes the control circuit 32, and a display unit driving circuit 33.

The control circuit 32 clocks time based on a reference clock oscillated by the crystal oscillator 31, and corrects current time based on time information subjected to signal processing by the receiving circuit 23. The display unit driving circuit 33 controls driving of the display means 10 based on a time clocked by the control circuit 32. Note that, the circuit unit 30 is an example of a clocking device of the present disclosure.

The electrical storage means 40 is a so-called secondary battery that stores power generated by the power generation device 60, and supplies the power to the circuit unit 30 and the like.

The rectifier circuit 50 rectifies a current generated by the power generation device 60, and supplies the current to the electrical storage means 40.

Power Generation Device

The power generation device 60 includes a generator 61, and a rotating weight 62, and converts mechanical energy obtained by rotation of the rotating weight 62 into electrical energy.

The generator 61 is a common generator having a power generation rotor, a power generation stator, a power generation coil, and the like, and generates power by rotating the power generation rotor, with mechanical energy obtained by rotation of the rotating weight 62 as power.

Rotating Weight

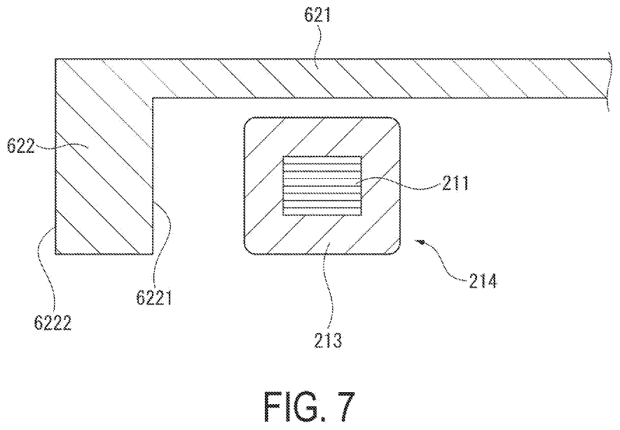

FIG. 6 is a plan view illustrating an outline of the rotating weight 62 and the antenna 21 of the present exemplary embodiment, and FIG. 7 is a cross-sectional view illustrating an outline of the rotating weight 62 and the antenna 21. Note that, in FIG. 6, the outer case 100 is omitted.

As illustrated in FIG. 6 and FIG. 7, the rotating weight 62 is configured to be substantially semicircular, and has an arm portion 621, a weight portion 622, and a rotary shaft O.

The arm portion 621 is a member that supports the weight portion 622. In the present exemplary embodiment, the arm portion 621 is formed using a non-magnetic material such as SUS301, SUS304, or brass having high processability. Thus, processing accuracy of the arm portion 621 can be improved.

Further, in the present exemplary embodiment, the arm portion 621 is provided along a diameter of a circle Q depicted by a rotational trajectory of an outer peripheral edge 6222 of the rotating weight 62.

The weight portion 622 is an arcuate band-like member that links both end portions of the arm portion 621, and is configured so as to be able to rotate about the rotary shaft O. In the present exemplary embodiment, the weight portion 622 has an inner peripheral edge 6221 and the outer peripheral edge 6222 that are arc-shaped.

Additionally, in the present exemplary embodiment, the weight portion 622 is formed using tungsten, which is a non-magnetic material. As a result, because the weight portion 622 of the rotating weight 62 is formed using tungsten having large specific gravity, mechanical energy obtained by rotation of the rotating weight 62 can be increased.

In this way, in the present exemplary embodiment, the arm portion 621 and the weight portion 622 configuring the rotating weight 62 are formed using a non-magnetic material, thus it is possible to reduce an effect of the rotating weight 62 on a fluctuation of a tuning frequency of the antenna 21.

Additionally, the rotating weight 62 includes an opening portion 623 defined by the arm portion 621 and the weight portion 622. In the present exemplary embodiment, the opening portion 623 has a semicircular shape, and is formed at a position to allow overlapping with the antenna 21 in plan view viewed from an axial direction of the rotary shaft O, as described below.

Disposition of Rotating Weight and Antenna

Next, disposition of the rotating weight 62 and the antenna 21 of the present exemplary embodiment will be described.

As illustrated in FIG. 6, in the present exemplary embodiment, the antenna 21 is disposed on an inner side in a radial direction of the rotating weight 62 than the circle Q depicted by the rotational trajectory of the outer peripheral edge 6222 of the rotating weight 62 in plan view. More specifically, the antenna 21 is disposed on the inner side in the radial direction of the rotating weight 62 than a circle R depicted by a rotational trajectory of the inner peripheral edge 6221 of the weight portion 622. As a result, in the present exemplary embodiment, the electronic watch 1 can be made smaller compared to a case where the antenna 21 is disposed on an outer side in the radial direction of the rotating weight 62 than the circle Q depicted by the rotational trajectory of the outer peripheral edge 6222 of the rotating weight 62. Furthermore, regardless of a rotational position of the rotating weight 62, the weight portion 622 does not cover the antenna 21 in plan view. As a result, the fluctuation in the tuning frequency of the antenna 21 can be reduced.

Then, the opening portion 623 of the rotating weight 62 is disposed at a position to allow overlapping with the antenna 21 in plan view. As a result, in the present exemplary embodiment, the coil portion 214 of the antenna 21 is configured so that, regardless of a rotational position of the rotating weight 62, a ratio of an area overlapping with the rotating weight 62 in plan view is equal to or less than 10%.

Here, when the rotating weight 62 is disposed at a position overlapping with the antenna 21 in plan view, the arm portion 621 and the coil portion 214 of the antenna 21 intersect in plan view. Specifically, the arm portion 621 is configured so that an angle of an acute angle or a right angle formed by a side along a longitudinal direction of the arm portion 621 and a side along a longitudinal direction of the coil portion 214 is equal to or greater than 45°, and equal to or less than 90°, more desirably equal to or greater than 60° and equal to or less than 90°. More specifically, in plan view, the arm portion 621 is configured so that, when a side of the arm portion 621 on the opening portion 623 side overlaps with a corner on the rotary shaft O side of the coil portion 214, an acute angle formed by a side on the rotary shaft O side of the coil portion 214 and a side on the opening portion 623 side of the arm portion 621 is equal to or greater than 45°, more desirably equal to or greater than 60°. In other words, in the present exemplary embodiment, the arm portion 621 is configured so as to be able to intersect the coil portion 214 in plan view. As a result, the coil portion 214 and the arm portion 621 do not overlap in parallel, so occurrence of eddy currents that cancel a magnetic field generated from the coil portion 214 can be suppressed. As a result, a reduction in reception performance of the antenna 21 can be suppressed.

Furthermore, in the present exemplary embodiment, as illustrated in FIG. 4 to FIG. 6, in plan view, both end shapes of the antenna core portion 211 of the antenna 21 have a curved shape along the inner peripheral edge 6221 of the weight portion 622. As a result, a magnetic field generated in the antenna 21 can be increased on an opposite side to the weight portion 622 with respect to the coil portion 214, making it possible to reduce a coefficient of fluctuation of the antenna tuning frequency, even when the antenna core portion 211 is disposed along an inner edge of the weight portion 622. Furthermore, because the antenna 21 can be disposed along an outer edge of the movement 200, it is possible to improve a degree of freedom of disposition of the components of the antenna 21 and the electronic watch 1.

Effect on Antenna Tuning Frequency Due to Overlapping Between Coil Portion and Rotating Weight

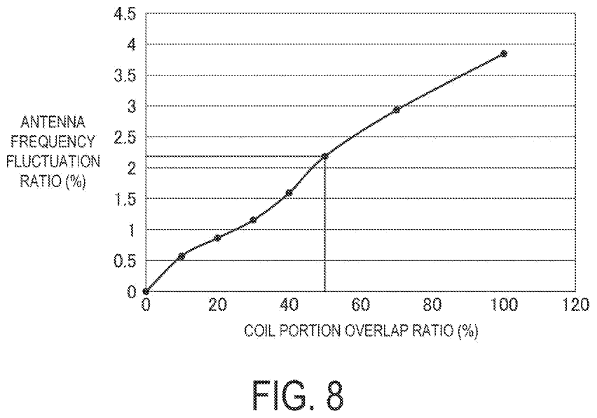

FIG. 8 is a diagram showing an effect on an antenna tuning frequency due to overlapping between the coil portion 214 and the rotating weight 62. Specifically, FIG. 8 shows a fluctuation of an antenna tuning frequency when a 0.5 mm thick metal corresponding to the arm portion 621 was brought close to the coil portion 214.

As shown in FIG. 8, when a ratio of an area of the coil portion 214 overlapping with the rotating weight 62 in plan view, that is, an overlap ratio of the coil portion 214 is 50%, a coefficient of fluctuation of the antenna tuning frequency can be suppressed to be approximately 2%. Then, when the fluctuation of the antenna tuning frequency is approximately 2%, reception sensitivity of the antenna 21 required when receiving a long wave standard radio wave can be ensured. In other words, when the overlap ratio of the coil portion 214 is equal to or less than 50%, the fluctuation of the tuning frequency of the antenna 21 can be set to be equal to or less than approximately 2%.

Then, in the present exemplary embodiment, as described above, the coil portion 214 is configured so that, regardless of a position of the rotating weight 62, the ratio of the area overlapping with the rotating weight 62 in plan view is equal to or less than 10%. As a result, even when the antenna 21 is disposed on the inner side in the radial direction of the rotating weight 62 than the circle Q depicted by the rotational trajectory of the outer peripheral edge 6222 of the rotating weight 62, the fluctuation of the tuning frequency of the antenna 21 can be set to be equal to or less than approximately 0.6%, and an effect of the antenna 21 on receiving a long wave standard radio wave can be suppressed.

Note that, when the overlap ratio of the coil portion 214 is greater than 50%, it is difficult to ensure the reception sensitivity of the antenna 21 required when receiving a long wave standard radio wave. Additionally, by setting the overlap ratio of the coil portion 214 to be equal to or greater than 5%, strength of the arm portion 621 of the rotating weight 62 can be increased, and thus, for example, deformation or breakage of the rotating weight 62 when strong impact such as drop impact is applied can be prevented.

### Operations and Effects of First Exemplary Embodiment

In the present exemplary embodiment, the following advantageous effects can be produced.

In the present exemplary embodiment, the rotating weight 62 has the opening portion 623 disposed at a position to allow overlapping with the antenna 21 in plan view, and does not cover the entire antenna 21 regardless of a rotational position. As a result, even when the antenna 21 is disposed on the inner side in the radial direction of the rotating weight 62 than the circle Q depicted by the rotational trajectory of the outer peripheral edge 6222 of the rotating weight 62, the fluctuation of the tuning frequency of the antenna 21 can be reduced. Therefore, effects on reception of a long wave standard radio wave by the antenna 21 can be suppressed, and the electronic watch 1 can be made smaller.

Furthermore, a disposition position of the rotation weight 62 is not restricted by the antenna 21, making it possible to increase a diameter of the rotating weight 62. Thus, power generation efficiency by the power generation device 60 can be improved.

In the present exemplary embodiment, regardless of a rotational position of the rotating weight 62, an area of the coil portion 214 of the antenna 21 overlapping with the rotating weight 62 in plan view is equal to or less than 50%, thus the fluctuation of the tuning frequency of the antenna 21 can be reduced.

In the present exemplary embodiment, the coil portion 214 of the antenna 21 and the arm portion 621 are disposed so as to intersect in plan view, that is, the coil portion 214 and the arm portion 621 do not overlap in parallel, so it is possible to suppress occurrence of eddy currents that cancel a magnetic field generated from the coil portion 214. As a result, the reduction in the reception performance of the antenna 21 can be suppressed.

In the present exemplary embodiment, the weight portion 622 of the rotating weight 62 does not cover the coil portion 214 in plan view, regardless of a rotational position of the rotating weight 62, so it is possible to reduce the fluctuation of the tuning frequency of the antenna 21.

In the present exemplary embodiment, the rotating weight 62 is formed using a non-magnetic material, making it possible to reduce the effect of the rotating weight 62 on the fluctuation of the tuning frequency of the antenna 21.

In the present exemplary embodiment, because the non-magnetic material forming the weight portion 622 of the rotating weight 62 is tungsten having large specific gravity, mechanical energy obtained by rotation of the rotating weight 62 can be increased. Thus, power generation efficiency by the power generation device 60 can be improved.

In the present exemplary embodiment, the arm portion 621 of the rotating weight 62 is formed using SUS301, SUS304, brass, or the like having high processability, so the processing accuracy of the arm 621 can be improved.

### Second Exemplary Embodiment

Next, an electronic watch 1A according to a second exemplary embodiment of the present disclosure will be described with reference to the drawings.

The electronic watch 1A of the second exemplary embodiment differs from the first exemplary embodiment described above in that an arc-shaped opening portion 623A is provided in a rotating weight 62A. Note that components of the second exemplary embodiment that are identical or similar to the corresponding components of the first exemplary embodiment are denoted by identical reference signs and that descriptions of these components are omitted.

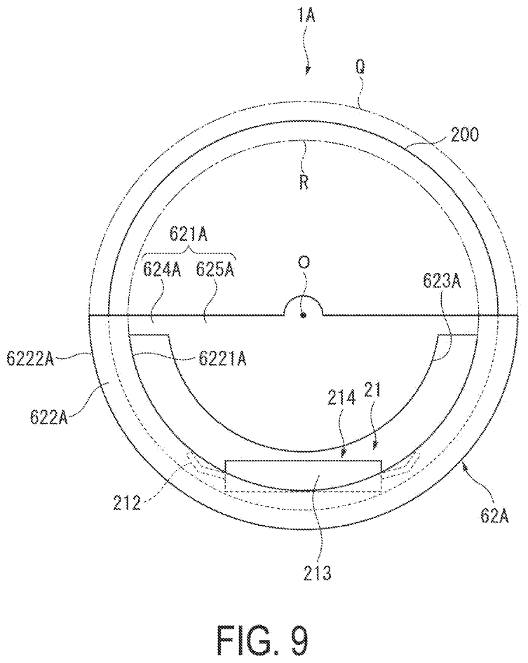

FIG. 9 is a plan view illustrating an outline of the rotating weight 62A and the antenna 21 of the present exemplary embodiment. Note that, the outer case 100 is omitted in FIG. 9.

As illustrated in FIG. 9, as in the case of the first exemplary embodiment described above, the rotating weight 62A is configured to be substantially semicircular, and has an arm portion 621A, a weight portion 622A, and the rotary shaft O.

The arm portion 621A is a member that supports the weight portion 622A in the same manner as in the first exemplary embodiment described above. In the present exemplary embodiment, the arm portion 621A includes an arm main body portion 624A provided along a diameter of the circle Q depicted by a rotational trajectory of an outer peripheral edge 6222A of the rotating weight 62A, and a cone portion 625A extending from the arm main body portion 624A in a semicircular shape. As a result, weight of the arm portion 621A can be increased by weight of the cone portion 625A, making it possible to increase mechanical energy obtained by rotation of the rotating weight 62A. As a result, power generation efficiency by the power generation device 60 can be improved.

The weight portion 622A is an arcuate band-like member that links both end portions of the arm main body portion 624A, and is configured so as to be able to rotate about the rotary shaft O. In the present exemplary embodiment, the weight portion 622A is formed using tungsten, which is a non-magnetic material, similar to the first exemplary embodiment described above.

Additionally, the rotating weight 62A includes an opening portion 623A defined by the arm portion 621A and the weight portion 622A. In the present exemplary embodiment, the opening portion 623A has an arc shape.

Further, in the present exemplary embodiment, similar to the first exemplary embodiment described above, the antenna 21 is disposed on an inner side in a radial direction of the rotating weight 62A than the circle Q depicted by a rotational trajectory of an outer peripheral edge 6222A of the weight portion 622A of the rotating weight 62A in plan view.

Specifically, the antenna 21 is disposed on an outer side in the radial direction than an inner peripheral side arc of the opening portion 623A, and is disposed at a position overlapping with the circle R depicted by a rotational trajectory of an inner peripheral edge 6221A of the rotating weight 62A. As a result, the opening portion 623A of the rotating weight 62A is disposed at a position to allow overlapping with the antenna 21 in plan view. Then, in the present exemplary embodiment, the coil portion 214 of the antenna 21 is configured so that, regardless of a position of the rotating weight 62A, a ratio of an area overlapping with the rotating weight 62A in plan view is equal to or less than 20%.

### Operations and Effects of Second Exemplary Embodiment

In the present exemplary embodiment, the following advantageous effects can be produced.

In the present exemplary embodiment, the rotating weight 62A includes the opening portion 623A disposed at a position to allow overlapping with the antenna 21 in plan view. Therefore, as in the case of the first exemplary embodiment described above, effects on reception of a long wave standard radio wave by antenna 21 can be suppressed, and the electronic watch 1A can be made smaller.

In the present exemplary embodiment, the arm portion 621A includes the arm main body portion 624A, and the cone portion 625A extending from the arm main body portion 624A in a semicircular shape. As a result, weight of the arm portion 621A can be increased by weight of the cone portion 625A, making it possible to increase mechanical energy obtained by rotation of the rotating weight 62A. As a result, power generation efficiency by the power generation device 60 can be improved.

### Third Exemplary Embodiment

Next, an electronic watch 1B according to a third exemplary embodiment of the present disclosure will be described with reference to the drawings.

The electronic watch 1B of the third exemplary embodiment differs from the first and second exemplary embodiments described above in that second arm portions 626B formed radially at a rotating weight 62B are provided, and eight opening portions 623B are provided. Note that components of the third exemplary embodiment that are identical or similar to the corresponding components of the first and second exemplary embodiments are denoted by identical reference signs and that descriptions of these components are omitted.

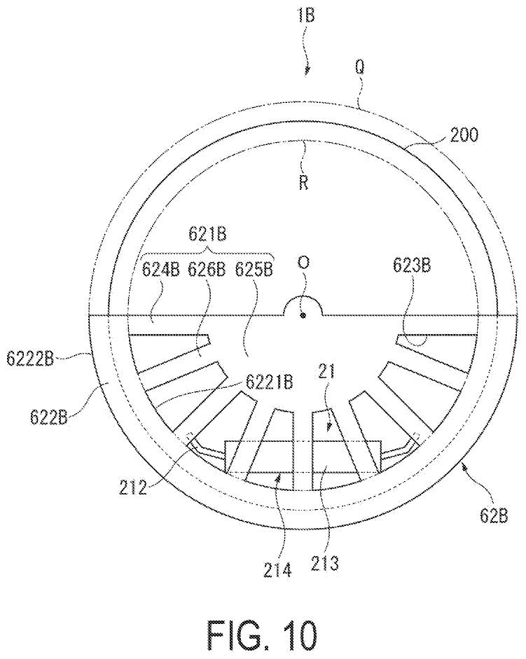

FIG. 10 is a plan view illustrating an outline of the rotating weight 62B and the antenna 21 of the present exemplary embodiment. Note that, the outer case 100 is omitted in FIG. 10.

As illustrated in FIG. 10, as in the cases of the first and second exemplary embodiments described above, the rotating weight 62B is configured to be substantially semicircular, and has an arm portion 621B, a weight portion 622B, and the rotary shaft O.

The arm portion 621B is a member that supports the weight portion 622B in the same manner as the first and second exemplary embodiments described above.

In the present exemplary embodiment, the arm portion 621B includes a first arm portion 624B provided along a diameter of the circle Q depicted by a rotational trajectory of an outer peripheral edge 6222B of the rotating weight 62B, a cone portion 625B extending in a semi-circular shape from the first arm portion 624B, and second arm portions 626B formed radially from the cone portion 625B. As a result, the arm portion 621B has the second arm portions 626B radially formed, and thus strength of the arm portion 621B can be increased.

The weight portion 622B is an arcuate band-like member that links both end portions of the first arm portion 624B and a tip portion of the second arm portion 626B, and is configured so as to be able to rotate about the rotary shaft O. In the present exemplary embodiment, the weight portion 622B is formed using tungsten, which is a non-magnetic material, similar to the first exemplary embodiment described above.

Additionally, the rotating weight 62B includes an opening portion 623B defined by the arm portion 621B and the weight portion 622B. In the present exemplary embodiment, the eight opening portions 623B are formed so as to sandwich the radially formed second arm portions 626B.

Further, in the present exemplary embodiment, similar to the first and second exemplary embodiments described above, the antenna 21 is disposed on an inner side in a radial direction of the rotating weight 62B than the circle Q depicted by a rotational trajectory of an outer peripheral edge 6222B of the weight portion 622B of the rotating weight 62B in plan view. More specifically, the antenna 21 is disposed on the inner side in the radial direction of the rotating weight 62B than the circle R depicted by a rotational trajectory of an inner peripheral edge 6221B of the weight portion 622B. Then, the opening portion 623B of the rotating weight 62B is disposed at a position to allow overlapping with the antenna 21 in plan view. As a result, in the present exemplary embodiment, the coil portion 214 of the antenna 21 is configured so that, regardless of a position of the rotating weight 62B, a ratio of an area overlapping with the rotating weight 62B in plan view is equal to or less than 30%.

Further, in the present exemplary embodiment, when the rotating weight 62B is disposed at a position overlapping with the antenna 21 in plan view, the second arm portions 626B and the coil portion 214 of the antenna 21 intersect in plan view. In other words, in the present exemplary embodiment, the second arm portions 626B are configured so as to be able to intersect the coil portion 214 in plan view. As a result, the coil portion 214 and the second arm portions 626B do not overlap in parallel, so occurrence of eddy currents that cancel a magnetic field generated from the coil portion 214 can be suppressed. As a result, a fluctuation in a tuning frequency of the antenna 21 can be reduced.

### Operations and Effects of Third Exemplary Embodiment

In the present exemplary embodiment, the following advantageous effects can be produced.

In the present exemplary embodiment, the rotating weight 62B includes the opening portion 623B disposed at a position to allow overlapping with the antenna 21 in plan view. Therefore, as in the cases of the first and second exemplary embodiments described above, effects on reception of a long wave standard radio wave by antenna 21 can be suppressed, and the electronic watch 1B can be made smaller.

In the present exemplary embodiment, the coil portion 214 of the antenna 21 and the second arm portions 626B are disposed so as to intersect in plan view, that is, the coil portion 214 and the second arm portions 626B do not overlap in parallel, so it is possible to suppress occurrence of eddy currents that cancel a magnetic field generated from the coil portion 214. As a result, a reduction in reception performance of the antenna 21 can be suppressed.

In the present exemplary embodiment, the arm portion 621B has the second arm portions 626B radially formed, and thus strength of the arm portion 621B can be increased.

### Fourth Exemplary Embodiment

Next, an electronic watch 1C according to a fourth exemplary embodiment of the present disclosure will be described with reference to the drawings.

The electronic watch 1C of the fourth exemplary embodiment differs from the first to third exemplary embodiments described above in that a rotating weight 62C includes notch portions 627C. Note that components of the fourth embodiment that are identical or similar to the corresponding components of the first to third exemplary embodiments are denoted by identical reference signs and that descriptions of these components are omitted.

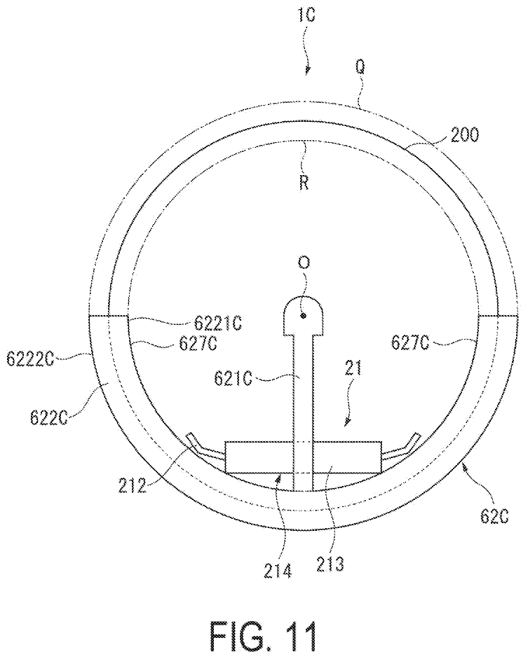

FIG. 11 is a plan view illustrating an outline of the rotating weight 62C and the antenna 21 of the present exemplary embodiment. Note that, the outer case 100 is omitted in FIG. 11.

As illustrated in FIG. 11, as in the cases of the first to third exemplary embodiments described above, the rotating weight 62C is configured to be substantially semicircular, and has an arm portion 621C, a weight portion 622C, and the rotary shaft O.

The arm portion 621C is a member that supports the weight portion 622C in the same manner as in the first to third exemplary embodiments described above.

In the present exemplary embodiment, the arm portion 621C is provided along a diameter of the circle Q depicted by a rotational trajectory of an outer peripheral edge 6222C of the weight portion 622C of the rotating weight 62C.

The weight portion 622C is an arcuate band-like member provided at a tip portion of the arm portion 621C, and is configured so as to be able to rotate about the rotary shaft O. In the present exemplary embodiment, the weight portion 622C is formed using tungsten, which is a non-magnetic material, similar to the first exemplary embodiment described above.

Additionally, the rotating weight 62C includes the notch portions 627C defined by the arm portion 621C and the weight portion 622C. In the present exemplary embodiment, two of the notch portions 627C are formed with the arm portion 621C interposed therebetween.

Further, in the present exemplary embodiment, similar to the first to third exemplary embodiments described above, the antenna 21 is disposed on an inner side in a radial direction of the rotating weight 62C than the circle Q depicted by a rotational trajectory of an outer peripheral edge 6222C of the weight portion 622C of the rotating weight 62C in plan view. More specifically, the antenna 21 is disposed on the inner side in the radial direction of the rotating weight 62C than the circle R depicted by a rotational trajectory of an inner peripheral edge 6221C of the weight portion 622C. Then, the notch portion 627C of the rotating weight 62C is disposed at a position to allow overlapping with the antenna 21 in plan view. As a result, in the present exemplary embodiment, the coil portion 214 of the antenna 21 is configured so that, regardless of a position of the rotating weight 62C, a ratio of an area overlapping with the rotating weight 62C in plan view is equal to or less than 10%.

Further, in the present exemplary embodiment, when the rotating weight 62C is disposed at a position overlapping with the antenna 21 in plan view, the arm portion 621C and the coil portion 214 of the antenna 21 intersect in plan view. In other words, in the present exemplary embodiment, the arm portion 621C is configured so as to be able to intersect the coil portion 214 in plan view. As a result, the coil portion 214 and the arm portion 621C do not overlap in parallel, so occurrence of eddy currents that cancel a magnetic field generated from the coil portion 214 can be suppressed. As a result, a reduction in reception performance of the antenna 21 can be suppressed.

### Operations and Effects of Fourth Exemplary Embodiment

In the present exemplary embodiment, the following advantageous effects can be produced.

In the present exemplary embodiment, the rotating weight 62C includes the notch portion 627C disposed at a position to allow overlapping with the antenna 21 in plan view. Therefore, as in the cases of the first to third exemplary embodiments, effects on reception of a long wave standard radio wave by antenna 21 can be suppressed, and the electronic watch 1C can be made smaller.

In the present exemplary embodiment, the coil portion 214 of the antenna 21 and the arm portion 621C are disposed so as to intersect in plan view, that is, the coil portion 214 and the arm portion 621C do not overlap in parallel, so it is possible to suppress occurrence of eddy currents that cancel a magnetic field generated from the coil portion 214. As a result, the reduction in the reception performance of the antenna 21 can be suppressed.

### Modification Example

Note that, the present disclosure is not limited to each of the above-described exemplary embodiments, and modifications, improvements, and the like within the scope in which the object of the present disclosure can be achieved are included in the present disclosure.

In the respective exemplary embodiments described above, the weight portions 622, 622A, 622B, and 622C are formed using tungsten, but are not limited thereto. For example, the weight portion may be formed using a non-magnetic material such as SUS301, SUS304, brass, or the like.

Similarly, in the respective exemplary embodiments described above, the arm portions 621, 621A, 621B, and 621C are formed using non-magnetic material such as SUS301, SUS304, or brass, but are not limited thereto. For example, the arm portion may be formed using tungsten.

Furthermore, the weight portion and the arm portion may be integrally formed using the same member.

In each of the exemplary embodiments described above, the antenna 21 is disposed in the 9 o'clock direction in plan view, but is not limited thereto. For example, the antenna may be disposed in a 6 o'clock direction, a 12 o'clock direction, or the like in plan view.

In each of the exemplary embodiments described above, the antenna 21 is configured to be capable of receiving a long wave standard radio wave, but is not limited to this. For example, the antenna may be configured to be capable of receiving GPS signals, radio waves, or the like.

### Summary of Present Disclosure

An electronic watch of the present disclosure includes a power generation device having a rotating weight rotating about a rotary shaft, and configured to convert mechanical energy obtained by rotation of the rotating weight into electrical energy, a clocking device configured to clock time, and an antenna disposed on an inner side in a radial direction of the rotating weight than a rotational trajectory of an outer peripheral edge of the rotating weight in plan view viewed from an axial direction of the rotary shaft, and configured to be capable of receiving a long wave standard radio wave, wherein the rotating weight has an opening portion or a notch portion disposed at a position to allow overlapping with the antenna in the plan view, and does not cover the entire antenna in the plan view regardless of a rotational position.

As a result, the rotation weight has the opening portion or the notch portion disposed at a position to allow overlapping with the antenna in planar view, and does not cover the entire antenna regardless of a rotational position, so even when the antenna is disposed on the inner side in the radial direction of the rotating weight than the rotational trajectory of the outer peripheral edge of the rotating weight, a fluctuation in a tuning frequency of the antenna can be reduced. Therefore, effects on reception of a long wave standard radio wave by the antenna can be suppressed, and the electronic watch can be made smaller.

In the electronic watch of the present disclosure, the antenna may include an antenna core portion and a coil portion, and the coil portion may have a ratio of an area overlapping with the rotating weight in the plan view equal to or less than 50%, regardless of a rotational position of the rotating weight.

As a result, the area of the coil portion of the antenna overlapping with the rotating weight in plan view is equal to or less than 50%, regardless of a rotational position of the rotating weight, so it is possible to reduce a fluctuation of a tuning frequency of the antenna.

In the electronic watch of the present disclosure, the rotating weight may include a weight portion and an arm portion that supports the weight portion, and the arm portion may be configured so as to be able to intersect the coil portion in the plan view.

As a result, the coil portion of the antenna and the arm portion are disposed so as to intersect in plan view, that is, the coil portion and the arm portion do not overlap in parallel, so it is possible to suppress occurrence of eddy currents that cancel a magnetic field generated from the coil portion. As a result, a reduction in reception performance of the antenna can be suppressed.

In the electronic watch of the present disclosure, the weight portion need not cover the coil portion in the plan view, regardless of a rotational position of the rotating weight.

As a result, the weight portion of the rotating weight does not cover the coil portion in plan view regardless of a rotational position of the rotating weight, so it is possible to reduce a fluctuation of a tuning frequency of the antenna.

In the electronic watch of the present disclosure, the rotating weight may be formed using a non-magnetic material.

As a result, the rotating weight is formed using a non-magnetic material, making it possible to reduce an effect of the rotating weight on a fluctuation of a tuning frequency of the antenna.

In the electronic watch of the present disclosure, the non-magnetic material may be tungsten.

As a result, because the non-magnetic material forming the rotating weight is tungsten having large specific gravity, mechanical energy obtained by rotation of the rotating weight can be increased. Thus, power generation efficiency by a power generation device can be improved.

What is claimed is:

1. An electronic watch, comprising:
a power generation device having a rotating weight rotating about a rotary shaft, and configured to convert mechanical energy obtained by rotation of the rotating weight into electrical energy;
a clocking device configured to clock time; and
an antenna disposed on an inner side in a radial direction of the rotating weight than a rotational trajectory of an outer peripheral edge of the rotating weight in plan view viewed from an axial direction of the rotary shaft, and configured to receive a long wave standard radio wave, wherein
the rotating weight has an opening portion or a notch portion disposed at a position that enables the rotating weight to overlap with the antenna in the plan view, and does not cover the entire antenna in the plan view regardless of a rotational position.

2. The electronic watch according to claim 1, wherein
the antenna includes an antenna core portion and a coil portion, and
the coil portion has a ratio of an area overlapping with the rotating weight in the plan view equal to or less than 50%, regardless of the rotational position of the rotating weight.

3. The electronic watch according to claim 2, wherein
the rotating weight includes a weight portion and an arm portion that supports the weight portion, and
the arm portion is configured to intersect the coil portion in the plan view.

4. The electronic watch according to claim 3, wherein
the weight portion does not cover the coil portion in the plan view, regardless of a rotational position of the rotating weight.

5. The electronic watch according to claim 1, wherein
the rotating weight is formed using a non-magnetic material.

6. The electronic watch according to claim 5, wherein
the non-magnetic material is tungsten.
